(19) United States
(12) Patent Application Publication
(10) Pub. No.: US 2019/0299564 A1
(43) Pub. Date: Oct. 3, 2019

(54) POLYMER LAMINATE ON ZINC-PHOSPHATE COATED GALVANIZED STEEL

(71) Applicant: AK Steel Properties, Inc., West Chester, OH (US)

(72) Inventor: James F. Evans, Middletown, OH (US)

(21) Appl. No.: 16/367,779

(22) Filed: Mar. 28, 2019

Related U.S. Application Data
(60) Provisional application No. 62/649,630, filed on Mar. 29, 2018.

(51) Int. Cl. B32B 15/08; B32B 15/04; B32B 15/18; B05D 7/14

(52) U.S. Cl. CPC B32B 15/08; B05D 7/14; B32B 15/18; B32B 15/043

(57) ABSTRACT

A laminated steel includes at least one laminate applied to one or more surfaces of a steel substrate using a zinc phosphate coating. Such a zinc phosphate coating can bond the steel substrate and laminate, while also eliminating the need for an additional cleaning step or pretreating step with a chromic solution prior to application of the laminate. This provides a more efficient and cost-effective process of applying the laminate to the steel.

### PRIORITY

This application claims priority to U.S. Provisional Application Ser. No. 62/649,630, entitled POLYMER LAMINATE ON GALVANIZED STEEL filed on Mar. 29, 2018, the disclosure of which is incorporated by reference herein.

### BACKGROUND

Galvanized steels may include a steel substrate coated with a zinc coating. This may provide a material with the corrosion protection of zinc in addition to the strength and formability of steel. Galvanized steels may be used in automotive, appliance, construction, HVAC, and other industries. In some instances, a polymer laminate is applied to an exterior surface of the galvanized steel. The laminate may be used to provide additional corrosion, impact, and/or abrasion resistance in subterranean or buried structures.

Prior to applying the laminate to the steel substrate, the steel surface is typically cleaned, dried, and pretreated with a chromic solution such as a hexavalent chromium (Cr6+) solution. For instance, the deposited chromium content of the pretreatment solution may range from about 135 to about 190 mg/m². After the pretreatment, the steel substrate is typically cleaned of any chromic pretreatment solution such that traces of the solution are rinsed. In some instances, traces of the pretreatment solution may adversely affect the bond between the laminate and the steel. In addition, the cleaning and chromic pretreating step can be time consuming, hazardous, and/or costly. Thus, there remains a need for applying a polymer laminate to a galvanized steel without the cleaning and chromic pretreating step.

### SUMMARY

A zinc phosphate coating is provided that may be applied to steel before the application of a laminate. The zinc phosphate coating may thereby eliminate the need to perform any cleaning and/or chromic pretreating step. This may result in a more safe, efficient, and cost-effective method to apply the laminate to steel.

### DESCRIPTION OF THE FIGURES

It is believed that the present invention will be better understood from the following description of certain examples taken in conjunction with the accompanying drawings, in which like reference numerals identify like elements.

FIG. 1 depicts a schematic of a method for applying a laminate to a steel substrate.

FIG. 2 depicts a cross-sectional view of a laminate applied to a steel substrate using a zinc phosphate coating.

The drawings are not intended to be limiting in any way, and it is contemplated that various embodiments of the present disclosure may be carried out in a variety of other ways, including those not necessarily depicted in the drawings. The accompanying drawings incorporated in and forming a part of the specification illustrate several aspects of the present disclosure, and together with the descriptions serve to explain the principles and concepts of the present disclosure; it being understood, however, that the present disclosure is not limited to the precise arrangements shown.

### DETAILED DESCRIPTION

The following description and embodiments of the present disclosure should not be used to limit the scope of the present disclosure. Other examples, features, aspects, embodiments, and advantages of the present disclosure will become apparent to those skilled in the art from the following description. As will be realized, the present disclosure may contemplate alternate embodiments than those exemplary embodiments specifically discussed herein without departing from the scope of the present disclosure. Accordingly, the drawings and descriptions should be regarded as illustrative in nature and not restrictive.

A laminated steel comprises at least one laminate applied to one or more surfaces of a steel substrate using a zinc phosphate coating. Such a zinc phosphate coating can bond the steel substrate and laminate, while also eliminating the need for an additional cleaning step and/or pretreating step, such as with a chromic solution, prior to application of the laminate. This may provide a more efficient process of applying the laminate to the steel. By eliminating the chromic pretreatment solution, the process eliminates the use of hexavalent chrome (Cr6+). This presents a cost savings and an environmental benefit. Eliminating the cleaning and pretreating step may also reduce the amount of equipment needed and the expense of pretreatment chemicals and their abatement and disposal.

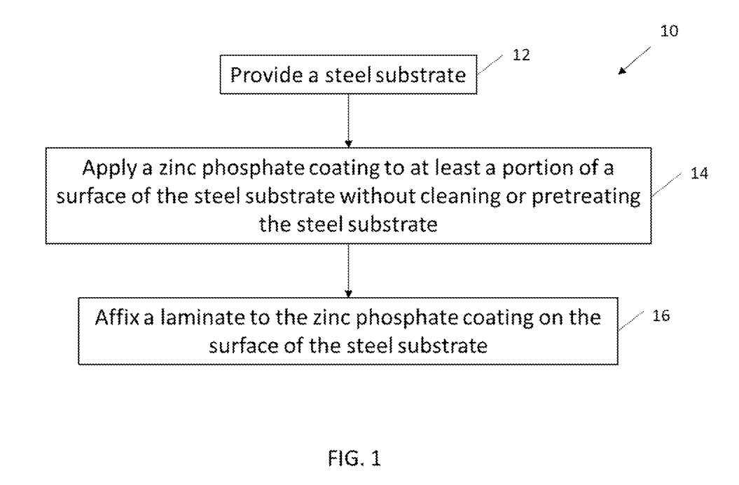

Referring to FIG. 1, a method (10) of applying a laminate to a steel substrate is shown. The method (10) comprises a step (12) of providing a steel substrate. Any suitable type of steel may be used for the steel substrate. For instance, the steel substrate may include galvanized steel such as hot-dip galvanized steel and/or electro-galvanized steel. In some other versions, the steel substrate may include cold rolled, hot rolled, pickled and/or uncoated steel. Still other suitable configurations for the steel substrate will be apparent to one with ordinary skill in the art in view of the teachings herein.

The method (10) then comprises a step (14) of applying a zinc phosphate coating to at least a portion of a surface of the steel substrate without cleaning or pretreating the steel substrate. Such a zinc phosphate coating may include a PAINTGRIP coating, available from AK Steel Corporation of West Chester, Ohio. Accordingly, the zinc phosphate coating may include zinc phosphate crystals to provide an activated surface on the zinc of the galvanized steel that promotes laminate adherence. The zinc phosphate coating may be applied to the steel substrate via immersion, dried in place, or any other method known for applying liquid to a surface.

Zinc phosphate levels of the coating may be between about 0.005 ounces per square feet and about 0.090 ounces per square feet, or between about 1.5 grams per square meter and about 30 grams per square meter.

A laminate may then be affixed to the zinc phosphate coating on the surface of the steel substrate, as provided in step (16) of the method (10) shown in FIG. 1. The laminate may comprise any suitable type of laminate, such as a polymer laminate, that requires heat when applied and/or thermal processing to cure or to apply adhesive. The laminate may be chemically resistant to harsh environmental conditions to thereby provide a barrier on the surface of the steel to protect the steel against premature corrosion. For instance, buried steels in low resistivity or extreme pH soils may be more robust with a polymer laminate. The laminate may also be designed to endure heating, curing, and/or cross-polymerization to result in a tough coating that may survive subsequent metal forming operations. In some versions, the Trenchcoat polymer from Valfilm of Findlay, Ohio may be used. Still other suitable configurations for the laminate will be apparent to one with ordinary skill in the art in view of the teachings herein.

To apply the laminate to the surface of the steel substrate, the steel substrate coated with the zinc phosphate coating may be heated to a peak metal temperature, such as between about 300° F. and about 500° F., such as about 400° F. The zinc phosphate may be applied as a dried in place coating and/or zinc phosphate crystals may be grown in-place on the surface of a temperature-controlled bath. The laminate may be a sheet and pressed on the surface of the steel with the zinc phosphate coating. The presence of zinc phosphate crystals of the zinc phosphate coating on the steel substrate may provide an active surface to which the polymer laminate adheres. The laminated steel may then be cured and cooled. In some versions, the laminated steel is further formed, stenciled and/or recoiled. Still other suitable methods for the applying the laminate will be apparent to one with ordinary skill in the art in view of the teachings herein.

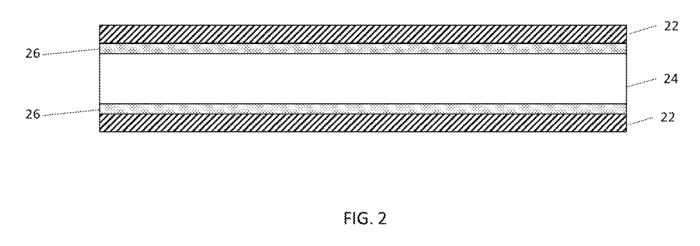

Accordingly, a laminated steel (20) may be formed as shown in FIG. 2 comprising at least one laminate (22) applied to one or more surfaces of a steel substrate (24) by a zinc phosphate coating (26).

Having shown and described various versions of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, versions, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

The following examples relate to various non-exhaustive ways in which the teachings herein may be combined or applied. It should be understood that the following examples are not intended to restrict the coverage of any claims that may be presented at any time in this application or in subsequent filings of this application. No disclaimer is intended. The following examples are being provided for nothing more than merely illustrative purposes. It is contemplated that the various teachings herein may be arranged and applied in numerous other ways. It is also contemplated that some variations may omit certain features referred to in the below examples. Therefore, none of the aspects or features referred to below should be deemed critical unless otherwise explicitly indicated as such at a later date by the inventors or by a successor in interest to the inventors. If any claims are presented in this application or in subsequent filings related to this application that include additional features beyond those referred to below, those additional features shall not be presumed to have been added for any reason relating to patentability.

### Example 1

A method of making a laminated steel comprising the steps of: providing a steel substrate; applying a zinc phosphate coating to at least a portion of a surface of the steel substrate without cleaning or pretreating the steel substrate; and affixing a laminate to the zinc phosphate coating on the surface of the steel substrate.

### Example 2

The method of example 1, wherein the steel substrate comprises a galvanized steel.

### Example 3

The method of examples 1 or 2, wherein the zinc phosphate coating is applied to the steel substrate via immersion.

### Example 4

The method of any of the examples 1 to 3, wherein the zinc phosphate level of the zinc phosphate coating is between about 0.005 ounces per square feet and about 0.090 ounces per square feet.

### Example 5

The method of any of the examples 1 to 4, wherein the laminate comprises a polymer laminate.

### Example 6

The method of any of the examples 1 to 5, wherein the steel substrate and zinc phosphate coating are heated to a peak metal temperature prior to affixing the laminate.

### Example 7

The method of any of the examples 1 to 6, wherein affixing the laminate comprises pressing the laminate onto the surface of the steel with the zinc phosphate coating.

### Example 8

The method of any of the examples 1 to 7, further comprising curing and cooling the laminated steel subsequent to affixing the laminate.

### Example 9

The method of any of the examples 1 to 8, further comprising forming the laminated steel.

### Example 10

The method of any of the examples 1 to 9, further comprising recoiling the laminated steel.

### Example 11

A method of making a laminated steel comprising the steps of applying a zinc phosphate coating to at least a portion of a surface of a steel substrate without pretreating the steel substrate with a chromic solution and affixing a laminate to the zinc phosphate coating on the surface of the steel substrate.

### Example 12

The method of example 11, wherein the zinc phosphate coating is applied without cleaning the surface of the steel substrate.

### Example 13

The method of examples 11 or 12, wherein the steel substrate comprises a galvanized steel.

### Example 14

The method of any of the examples 11 to 13, wherein the zinc phosphate coating is applied to the steel substrate via immersion.

### Example 15

The method of any of the examples 11 to 14, wherein the zinc phosphate level of the zinc phosphate coating is between about 0.005 ounces per square feet and about 0.090 ounces per square feet.

### Example 16

The method of any of the examples 11 to 15, wherein the laminate comprises a polymer laminate.

### Example 17

The method of any of the examples 11 to 16, wherein the steel substrate and zinc phosphate coating are heated to a peak metal temperature prior to affixing the laminate.

### Example 18

A laminated steel comprising a laminate applied to at least a portion of a surface of a steel substrate via a zinc phosphate coating without cleaning or pretreating the surface of the steel substrate.

### Example 19

The laminated steel of example 18, wherein the steel substrate comprises a galvanized steel.

### Example 20

The laminated steel of example 18 or 19, wherein the laminate comprises a polymer laminate.

What is claimed is:

1. A method of making a laminated steel comprising the steps of:
providing a steel substrate;
applying a zinc phosphate coating to at least a portion of a surface of the steel substrate without pretreating the steel substrate with a chromic solution; and
affixing a laminate to the zinc phosphate coating on the surface of the steel substrate.

2. The method of claim 1, wherein the steel substrate comprises a galvanized steel.

3. The method of claim 1, wherein the zinc phosphate coating is applied to the steel substrate via immersion.

4. The method of claim 1, wherein the zinc phosphate level of the zinc phosphate coating is between about 0.005 ounces per square feet and about 0.090 ounces per square feet.

5. The method of claim 1, wherein the laminate comprises a polymer laminate.

6. The method of claim 1, wherein the steel substrate and zinc phosphate coating are heated to a peak metal temperature prior to affixing the laminate.

7. The method of claim 1, wherein affixing the laminate comprises pressing the laminate onto the surface of the steel with the zinc phosphate coating.

8. The method of claim 1 further comprising curing and cooling the laminated steel subsequent to affixing the laminate.

9. The method of claim 1 further comprising forming the laminated steel.

10. The method of claim 1 further comprising recoiling the laminated steel.

11. A method of making a laminated steel comprising the steps of applying a zinc phosphate coating to at least a portion of a surface of a steel substrate without pretreating the steel substrate with a chromic solution and affixing a laminate to the zinc phosphate coating on the surface of the steel substrate.

12. The method of claim 11, wherein the zinc phosphate coating is applied without cleaning the surface of the steel substrate.

13. The method of claim 11, wherein the steel substrate comprises a galvanized steel.

14. The method of claim 11, wherein the zinc phosphate coating is applied to the steel substrate via immersion.

15. The method of claim 11, wherein the zinc phosphate level of the zinc phosphate coating is between about 0.005 ounces per square feet and about 0.090 ounces per square feet.

16. The method of claim 11, wherein the laminate comprises a polymer laminate.

17. The method of claim 11, wherein the steel substrate and zinc phosphate coating are heated to a peak metal temperature prior to affixing the laminate.

18. A laminated steel comprising a laminate applied to at least a portion of a surface of a steel substrate via a zinc phosphate coating without cleaning or pretreating the surface of the steel substrate.

19. The laminated steel of claim 18, wherein the steel substrate comprises a galvanized steel.

20. The laminated steel of claim 18, wherein the laminate comprises a polymer laminate.
